(19) United States
(12) Patent Application Publication
(10) Pub. No.: US 2025/0258764 A1
(43) Pub. Date: Aug. 14, 2025

(54) PSEUDO ACCESS LOAD GENERATION MECHANISM AND COMPUTER THEREWITH

(71) Applicant: DENSO CORPORATION, Kariya-city (JP)

(72) Inventor: Makoto HASEGAWA, Kariya-city (JP)

(21) Appl. No.: 19/013,085

(22) Filed: Jan. 8, 2025

(30) Foreign Application Priority Data
Feb. 9, 2024 (JP) 2024-018962

(51) Int. Cl. G06F 11/3698

(52) U.S. Cl. CPC G06F 11/3698

(57) ABSTRACT

A pseudo-access load generation mechanism is provided inside of a computer, and includes a pseudo-access load generation unit that generates a pseudo-access load on the memory module based on the access profile information 80 acquired by the profile acquisition unit or the information for the self-running mode stored by the information storage unit for the self-running mode. Therefore, a sufficiently high load state of the memory module can be generated, which corresponds to the load state of the memory module when the plurality of application programs are executed by the processor.

### CROSS REFERENCE TO RELATED APPLICATION

The present application claims the benefit of priority from Japanese Patent Application No. 2024-018962 filed on Feb. 9, 2024. The entire disclosure of the above application is incorporated herein by reference.

### TECHNICAL FIELD

The present disclosure relates to a pseudo-access load generation mechanism that generates a pseudo access load on a memory module included in a computer, and a computer including the pseudo access load generation mechanism.

### BACKGROUND ART

For example, a conceivable technique teaches a program testing device that verifies the validity of various response processes in response to accesses to computer hardware resources by an under test program when verifying the operation of the under test program running on the computer. Specifically, the test device in the conceivable technique is equipped with a pseudo-driver that generates various pseudo-responses by replacing the normal return value from an interface that provides service of an access to the computer hardware resources with an arbitrary response value based on predetermined parameters, and performs operation verification for arbitrary response processing via the pseudo-driver.

### SUMMARY OF INVENTION

According to an example, a pseudo-access load generation mechanism may be provided inside of a computer, and may include a pseudo-access load generation unit that generates a pseudo-access load on the memory module based on the access profile information 80 acquired by the profile acquisition unit or the information for the self-running mode stored by the information storage unit for the self-running mode. Therefore, a sufficiently high load state of the memory module can be generated, which corresponds to the load state of the memory module when the plurality of application programs are executed by the processor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing the overall configuration of a computer equipped with a pseudo access load generation mechanism according to a first embodiment, and peripheral devices of the computer;

FIG. 2 is an explanatory diagram for explaining an example of access profile information;

FIG. 3 is a flowchart showing an example of a process for generating a pseudo access load on a memory module, which is executed in a pseudo access load generation mechanism; and

FIG. 4 is a diagram showing the overall configuration of a computer including a pseudo-access load generation mechanism according to a second embodiment, and peripheral devices of the computer.

### DETAILED DESCRIPTION

As described above, it is an object for the testing device of the conceivable technique to verify the operation of a response process performed by a computer hardware resource of an under-test program.

Here, it is conceivable that a plurality of application programs are implemented in a computer. In this case, a plurality of application programs may be developed individually and then finally integrated and implemented on a computer. In the development process, when each application program is developed, the developed application program alone can be implemented and run on a computer to verify the operation of the developed application program.

However, even if the results of the expected operation are acquired when the operational verification of a single application program is executed, there may be occurred such that the results of the expected operation are not acquired for at least one application program when the operational verification is performed in an integrated state of multiple application programs. One of the reasons for this case is estimated that a plurality of application programs compete for resources related to the memory module and interfere with each other's operations.

Therefore, when a number of application programs less than a plurality of application programs are implemented in a computer and their operation is verified, it is possible to simulate a high load condition on the memory module and verify the operation of the number of application programs less than a plurality of application programs under this high load environment. Thus, it is possible to check during the development process of each application program whether or not each application program operates as expected manner in a state where a plurality of application programs are integrated.

When data acquired from an external computer or the like is written to the memory module via an external interface (IF) or data read from the memory module is transmitted to an external computer or the like in order to generate a high-load state of the memory module, it may be difficult to generate a sufficiently high-load state because the amount of data per unit time of communication via the external IF (i.e., the data bandwidth of the external IF) is less than the amount of data read and written per unit time in the memory module (i.e., the data bandwidth of the memory module).

Furthermore, when a high load state of a memory module is generated using a processor inside a computer, the operation of the processor is affected, and there is a risk that the operation of the application program as a verification target is also affected. Therefore, it may not be possible to perform proper operation verification in an environment that simulates a state in which multiple application programs are integrated.

The present embodiments have been made in consideration of the above-described points, and has a first object to provide a pseudo-access load generation mechanism capable of generating a pseudo-access load in a computer in which a processor is designed to execute multiple application programs, in order to properly perform operation verification of a number of application programs that is fewer than the multiple application programs. A second object of the present embodiments is to provide a computer equipped with the pseudo access load generation mechanism.

In order to achieve the first object described above, a pseudo access load generation mechanism according to the present embodiments is a pseudo access load generation mechanism for enabling a simulation of an access load on a memory module in a case where a processor executes a plurality of application programs when a number of application programs less than the number of the plurality of application programs is executed by the processor for operation verification in a computer in which the processor is designed to execute the plurality of application programs.

The pseudo access load generation mechanism includes: an acquisition or storage unit that acquires or stores information for applying a pseudo access load to a memory module; and a pseudo-access load generation unit that generates the pseudo access load on the memory module based on the information acquired or stored by the acquisition or storage unit.

The pseudo access load generation mechanism is characterized in that the pseudo access load generation mechanism is provided inside the computer separately from the processor.

In order to achieve the second object described above, a computer according to the present embodiments is a computer that is designed to execute a plurality of application programs by a processor.

The computer includes: a memory module that is accessed by the processor for writing and reading data when the plurality of application programs are executed; and a pseudo-access load generation mechanism (30, 133) having an acquisition or storage unit that acquires or stores information for applying a pseudo access load to the memory module and a pseudo-access load generation unit that generates the pseudo-access load on the memory module based on the information acquired or stored by the acquisition or storage unit.

The pseudo-access load generation mechanism is provided in the computer separately from the processor.

When a number of application programs less than the plurality of application programs are executed by the processor to verify the operation, the pseudo access load generated by the pseudo access load generation mechanism makes it possible to simulate the access load on the memory module in a case where the processor executes the plurality of application programs.

As described above, the pseudo access load generation mechanism according to the present embodiments is provided inside the computer. The pseudo-access load generation mechanism includes a pseudo-access load generation unit that generates a pseudo-access load on the memory module based on the information for applying the pseudo-access load acquired or stored by the acquisition or storage unit. Therefore, according to the pseudo-access load generation mechanism disclosed herein, it is possible to generate a sufficiently high load state of the memory module that corresponds to the load state of the memory module in a case where the plurality of application programs are executed by the processor, which is different from a case where the memory module is accessed via an external IF, for example.

Furthermore, the pseudo-access load generation mechanism according to the present embodiments is provided inside the computer, separately from the processor of the computer. Therefore, it is possible to restrict the influence to the operation of the processor since the pseudo-access load generation mechanism applies the pseudo-access load on the memory module. Therefore, in a computer having a pseudo access load generation mechanism, it is possible to properly verify the operation of an application program executed by a processor.

The reference signs and/or numerals in parentheses are merely added to indicate examples of correspondence relationships with concrete structures in the below-described embodiments in order to facilitate the understanding of the present embodiments, which has no intention to limit the scope of the present embodiments in any manner.

Hereinafter, embodiments of a pseudo access load generation mechanism and a computer according to the present embodiments will be described with reference to the drawings. In the following description of the embodiments, the same or similar components may be denoted by the same reference numerals throughout the drawings, and the description thereof may be omitted. When only a part of a configuration is described in each embodiment, a configuration of another embodiment described earlier can be applied to the other part of the configuration. In addition to the combination of the configurations explicitly described in the description of each embodiment, the configurations of multiple embodiments may be partially combined even if not explicitly described as long as there is no difficulty in the combination.

### First Embodiment

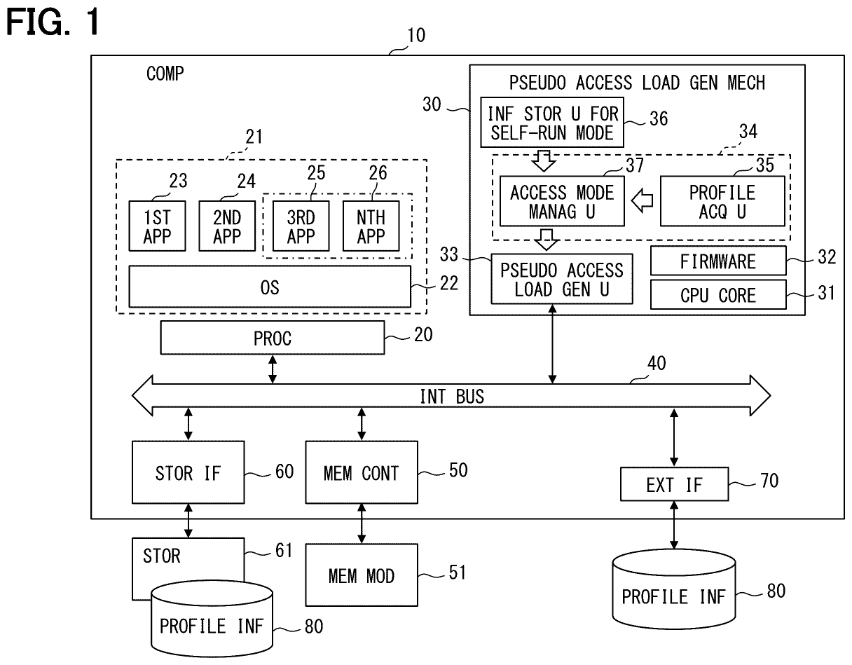

FIG. 1 is a diagram showing the overall configuration of a computer 10 including a pseudo-access load generation mechanism 30 according to a present embodiment, and peripheral devices of the computer 10. The computer 10 according to the present embodiment can be used, for example, to control various control target devices mounted on a vehicle. Here, application examples of the computer 10 according to the present embodiments are not limited to the control of control target devices mounted on the vehicle, and may be applied to the control of control target devices for other purposes. For example, the computer 10 according to the present embodiments may be applied to control of a control target device for controlling the operation of a robot or a construction machine.

As shown in FIG. 1, the computer 10 includes a processor 20, a pseudo access load generation mechanism 30, an internal bus 40, a memory controller 50, a storage interface (i.e., IF) 60, and an external IF 70. The processor 20, the pseudo-access load generation mechanism 30, the memory controller 50, the storage interface (i.e., IF) 60, and the external IF 70 are each connected to the internal bus 40. The configuration of the computer 10 shown in FIG. 1 is merely an example. For example, a part of the configuration shown in FIG. 1 may be omitted. Alternatively, any configuration may be added to the configuration shown in FIG. 1.

As shown in FIG. 1, a plurality of application programs, specifically, first to Nth application programs 23 to 26 are designed to be installed on the computer 10. In the computer 10, a processor 20 executes first to Nth application programs 23 to 26 on an operating system 22, thereby controlling a control target device and the like.

The operating system 22 and the first to Nth application programs 23 to 26 are all software programs, and are stored in the storage 61. When the computer 10 starts operating, the operating system 22 and the first through Nth application programs 23 through 26 are loaded into the memory module 51, respectively. This enables the processor 20 to execute an operating system 22 and software programs 21 such as first through Nth applications. The operating system 22 controls the basic operations of the computer 10, and, for example, manages hardware resources such as the processor 20, the memory module 51, and the storage 61, and provides an interface for the first to Nth application programs 23 to 26 to use the hardware resources.

The processor 20 is a processing unit that performs various calculation processes for executing the first to Nth application programs 23 to 26. The processor 20 includes at least one calculation core such as a central processing unit (i.e., CPU). Furthermore, the processor 20 may include modules such as a graphics processing unit (i.e., GPU) for performing image processing and a neural processing unit (i.e., NPU) for processing artificial intelligence (i.e., AI) tasks. When performing various processes, the processor 20 accesses the memory module 51 via the memory controller 50 in order to temporarily store data in the memory module 51 and to read out the stored data.

The memory controller 50 provides an interface function such as reading and writing data to the memory module 51 in the computer system. For example, when a required address is designated and an instruction to read data is input, the memory controller 50 reads the data stored at the designated address and returns the read data. Furthermore, if the memory module 51 includes a dynamic random access memory (i.e., DRAM), the memory controller 50 also refreshes the DRAM.

The memory module 51 includes a DRAM, a SRAM (i.e., Static RAM), and the like. Various software programs 21 are loaded into the memory module 51 for execution by the processor 20, as described above. As a result, various software programs 21 are stored in the memory module 51. Furthermore, when the processor 20 executes the first to Nth application programs 23 to 26, various data are written to and read from the memory module 51, such as data used for the calculation processing in each program, data acquired by the calculation processing, and data for image processing and AI tasks. In FIG. 1, the memory module 51 is shown as being provided outside of the computer 10 and connected to the memory controller 50. Alternatively, the memory module 51 may be built into the computer 10.

The storage IF 60 provides the storage 61 with interface functions such as reading and writing data. The storage 61 includes a non-volatile storage medium such as a flash memory. The storage 61 stores the software program 21 that is executed by the processor 20. Furthermore, the storage 61 may store access profile information 80 for generating a pseudo access load on the memory module 51 by the pseudo access load generation mechanism 30. In FIG. 1, the storage 61 is shown as being provided outside the computer 10 and connected to the storage IF 60. Alternatively, the storage 61 may be built into the computer 10.

The external IF 70 is a circuit that provides an interface for the computer 10 to communicate with an external computer or the like. The external IF 70 can be realized by using a chip or the like on which a communication circuit conforming to a communication standard for communication with an external computer or the like is implemented. The above-described access profile information 80 can also be input to the computer 10 via the external IF 70 as shown in FIG. 1.

Here, when the plurality of application programs (i.e., the first to Nth application programs 23 to 26) are designed to be implemented, as in the case of computer 10 of this embodiment, the first to Nth application programs 23 to 26 may be developed individually and then finally integrated and implemented in the computer 10. In the development process, when each application program is developed, the developed application program alone can be implemented and run on a computer 10 to verify the operation of the developed application program.

However, even if the results of the expected operation are acquired when the operational verification of a single application program is executed in the computer 10 or an environment equivalent to the computer 10, there may be occurred such that the results of the expected operation are not acquired for at least one application program when the operational verification is performed in an integrated state of the plurality of application programs 23 to 26. One of the reasons for this case is estimated that a plurality of application programs 23 to 26 compete for hardware resources related to the memory module 51 and interfere with each other's operations.

Therefore, when a certain number of application programs fewer than the number of the plurality of application programs 23 to 26 are implemented in the computer 10 and their operation is verified (for example, when only the first and second application programs 23, 24 among the first to Nth application programs 23 to 26 are implemented in the computer 10 and their operation is verified), it is possible to generate a pseudo-high load state on the memory module 51. Thus, it is possible to simulate a high load state of the memory module 51 as if the plurality of application programs 23 to 26 were being operated when the computer 10 or the like operates the certain number of application programs fewer than the plurality of application programs 23 to 26. Thus, it is possible to check during the development process of each application program whether or not each application program operates as expected manner in a state where a plurality of application programs 23 to 26 are integrated. Confirmation of whether or not each application program operates as expected manner, that is, operational verification, can be determined based on, for example, the operation time of the application program as a verification target, the access time to the memory module 51, and the like.

In order to generate a high-load state of the memory module 51, when data acquired from an external computer or the like is written to the memory module 51 via the external IF 70, or data read from the memory module 51 is transmitted to an external computer or the like via the external IF 70, it is difficult to generate a sufficiently high-load state because the data bandwidth of communication via the external IF 70 is smaller than the data bandwidth of the memory module 51. Furthermore, when a high load state of a memory module 51 is generated using a processor 20 inside a computer 10, the operation of the processor 20 is affected, and there is a risk that the operation of the application program as a verification target is also affected. Therefore, it may not be possible to perform proper operation verification in an environment that simulates a state in which multiple application programs 23 to 26 are integrated.

Therefore, in this embodiment, a pseudo-access load generation mechanism 30 capable of applying a pseudo-access load to the memory module 51 is provided inside the computer 10 separately from the processor 20. The pseudo-access load generation mechanism 30 includes a CPU core 31, a firmware 32, a pseudo-access load generation unit 33, a profile acquisition unit 35, an information storage unit 36 for self-running mode, and an access mode management unit 37. In the configuration shown in FIG. 1, the profile acquisition unit 35 and the access mode management unit 37 are embodied by the software program 34 executed by the CPU core 31.

The CPU core 31 is a processing unit that performs various calculation processes to execute the software programs 34 such as the profile acquisition unit 35 and the access mode management unit 37. The CPU core 31 uses a simple calculation core than the processor 20. This feature provides to suppress an increase in costs caused by providing the pseudo-access load generation mechanism 30 inside the computer 10. The firmware 32 is software incorporated to perform basic control of the hardware such as the pseudo access load generation unit 33 when the CPU core 31 executes software programs 34 such as the profile acquisition unit 35 and the access mode management unit 37. The firmware 32 and the software programs 34 may be loaded into the memory module 51 and executed. Alternatively, the pseudo access load generation mechanism 30 may have an internal dedicated memory, and the firmware 32 and the software program 34 may be executed by being loaded into the dedicated memory.

The pseudo-access load generation unit 33 is a hardware circuit that is connected to the internal bus 40 and is configured to be able to access the memory module 51 via the internal bus 40, for inputting and outputting data. Specifically, the pseudo access load generation unit 33 writes data to a memory area at a specified address in the memory module 51, or reads data from a memory area at a specified address in the memory module 51, based on the access profile information 80 or information for the self-running mode. Such data reading and writing realize the high load state in the memory module 51.

The profile acquisition unit 35 acquires the access profile information 80, and provides the access profile information 80 to the simulated access load generation unit 33 via the access mode management unit 37. The access profile information 80 is loaded into the memory module 51 via the storage IF 60 or the external IF 70. The access profile information 80 can be loaded into the memory module 51 by, for example, an instruction from the CPU core 31 or the processor 20 of the pseudo access load generation mechanism 30. The profile acquisition unit 35 can acquire the access profile information by reading the access profile information from the memory module 51. Here, a dedicated memory for storing the access profile information 80 may be provided in the pseudo access load generation mechanism 30, and the profile acquisition unit 35 may acquire the access profile information 80 by reading the access profile information 80 from the dedicated memory.

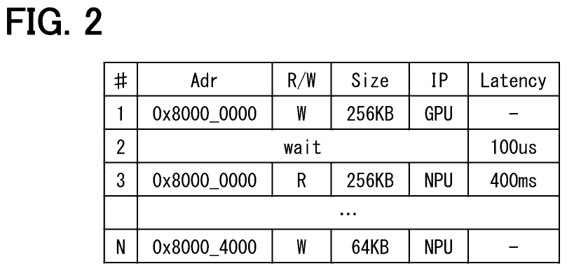

The access profile information 80 is information that specifies multiple access data in sequence, including, for example, the address of the memory module 51 to be accessed, the type of access (i.e., write or read), data size, module information indicating which module of the processor 20 handles the data, and waiting time, as shown in FIG. 2. The access profile information 80 is generated, for example, so as to generate an access load that is reduced by the number of application modules as a target of the operational verification, based on the actual access load to the memory module in another product that is expected to generate an access load similar to the access load to the memory module 51 by the plurality of application programs 23-26 that are designed to be implemented. A plurality of types of access profile information 80 may be generated, each of which has a different load level of the pseudo access load. For example, the access profile information 80 to be loaded into the memory module 51 may be switched in response to an instruction from the processor 20.

For example, in the example shown in FIG. 2, the first access data #1 instructs writing image processing data for the GPU module with a data size of 256 KB to address 0 x 800 _ 000 of the memory module 51. The second access data #2 instructs waiting for 100 μs. The third access data #3 instructs reading data for the NPU module having a data size of 256 KB from address 0 x 800 _ 000 of the memory module 51.

The self-running mode information storage unit 36 has a plurality of internal registers for storing the self-running mode information. A plurality of internal registers store setting values such as the read/write ratio when accessing the memory module 51 and the data size per unit time (i.e., data bandwidth). The pseudo access load generation unit 33 generates a pseudo access load according to the read/write ratio and the data bandwidth specified by the information for the self running mode. The address of the memory module 51 to be accessed may be determined randomly based on a random number, for example, or may be determined according to predetermined rules (such as the initial value of the address and the countable value of the address for each access).

The self-running mode information storage unit 36 can store the self-running mode information by storing the self-running mode information in advance. In this case, the self-running mode information storage unit 36 may store a plurality of types of self-running mode information with different access load conditions of the memory module 51. In this case, for example, by switching the information for the self-running mode to be adopted in response to an instruction from the processor 20, it is possible to adjust the load level of the pseudo access load that is to be generated. Alternatively, the processor 20 may write optimal self-running mode information to the self-running mode information storage unit 36 each time before a pseudo access load is generated in the self-running mode.

The access mode management unit 37 manages which mode to execute: a profile reproduction mode that applies a pseudo-access load to the memory module 51 based on the access profile information 80 provided from the profile acquisition unit 35; or a self-running mode that applies a pseudo-access load to the memory module 51 based on information for the self-running mode provided from the information storage unit 36 for the self-running mode. Furthermore, for example, when an instruction to adjust the load level of the pseudo access load is given by the processor 20, the access mode management unit 37 also manages switching of the access profile information 80 and switching or rewriting of the information for the self-running mode.

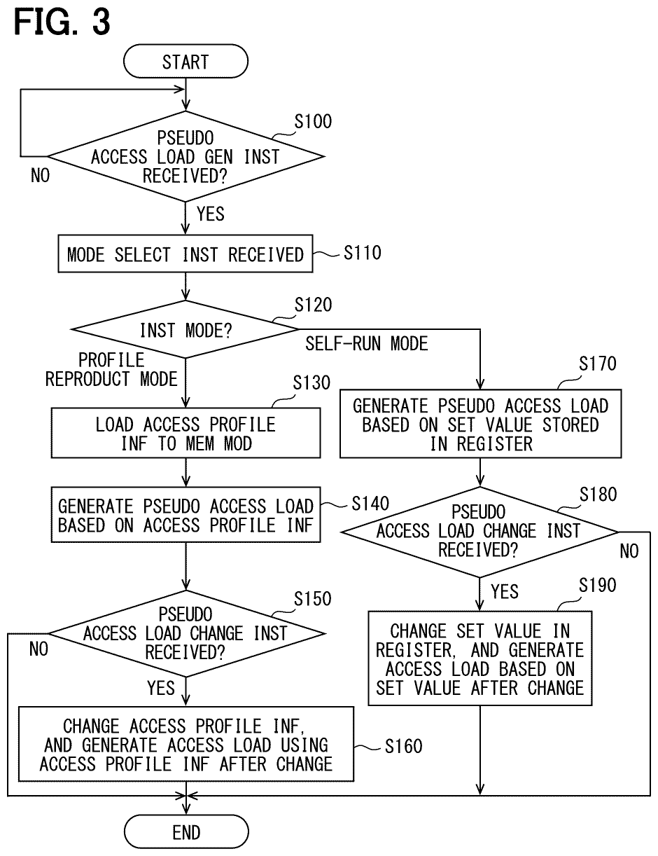

Next, an example of a process executed by the pseudo-access load generation mechanism 30 for generating a pseudo-access load in the memory module 51 will be described with reference to the flowchart of FIG. 3. The process shown in the flowchart of FIG. 3 is executed, for example, when the computer 10 is turned on.

In step S100, the pseudo-access load generation mechanism 30 determines whether or not a pseudo-access generation instruction signal has been received from the processor 20, for example. As shown in FIG. 1, for example, when only the first and second application programs 23, 24 of the first to Nth application programs 23-26 are implemented in the computer 10 and their operation is verified, the processor 20 can instruct the pseudo-access load generation mechanism 30 to generate a pseudo-access load in conjunction with the start of the operation verification. The pseudo-access load generation instruction signal can also be provided to the pseudo-access load generation mechanism 30 from an external computer connected to the external IF 70.

In step S110, the pseudo-access load generation mechanism 30 receives a mode selection instruction signal from the processor 20, for example. The mode selection instruction signal instructs the pseudo-access load generation mechanism 30 which mode to execute, either the profile reproduction mode or the self-running mode. The mode selection instruction signal can also be given to the pseudo-access load generation mechanism 30 from an external computer connected to the external IF 70.

In step S120, the pseudo-access load generation mechanism 30 determines whether the profile reproduction mode or the self-running mode has been instructed as the mode to be executed. If the profile reproduction mode is instructed, the pseudo access load generation mechanism 30 proceeds to the process of step S130. On the other hand, if the self-running mode is instructed, the pseudo-access load generation mechanism 30 proceeds to the process of step S170.

In step S130, the pseudo access load generation mechanism 30 or the processor 20 loads the access profile information 80 into the memory module 51 via the storage IF 60 or the external IF 70. Thus, the profile acquisition unit 35 of the pseudo access load generation mechanism 30 can acquire the access profile information 80 by reading out the access profile information 80 from the memory module 51 at high speed, and provide the access profile information 80 to the pseudo access load generation unit 33.

In step S140, the pseudo access load generation mechanism 30 (i.e., the pseudo access load generation unit 33) generates a pseudo access load by accessing the memory module 51 in accordance with each access data included in the access profile information 80 based on the access profile information 80. In this way, execution of an access in accordance with each access data included in the access profile information 80 corresponds to reproduction of the access profile defined by the access profile information 80. For this reason, in this embodiment, the mode in which an access load is generated based on the access profile information 80 is defined as a profile reproduction mode.

In step S140, when access to the memory module 51 in accordance with all access data included in the access profile information 80 is terminated, or when termination is instructed, for example, by the processor 20, the pseudo-access load generation unit 33 terminates the generation of the pseudo-access load in the profile reproduction mode. Thereafter, the pseudo-access load generation mechanism 30 proceeds to the process of step S150.

In step S150, the pseudo access load generation mechanism 30 determines whether or not an instruction to change the pseudo access load, that is, an instruction to adjust the load level of the pseudo access load, has been received from the processor 20, for example. As described above, the load level of the pseudo access load can be adjusted by switching the access profile information 80 for generating the pseudo access load. If it is determined that an instruction to change the pseudo access load has been received, the pseudo access load generation mechanism 30 proceeds to the process of step S160. On the other hand, if it is determined that the instruction to change the pseudo access load has not been received, the pseudo access load generation mechanism 30 ends the process shown in the flowchart of FIG. 3.

In step S160, the pseudo access load generation mechanism 30 or the processor 20 loads the new access profile information 80 into the memory module 51 via the storage IF 60 or the external IF 70. As a result, the access profile information 80 for generating the pseudo access load is changed. Then, the pseudo access load generation unit 33 generates a pseudo access load by accessing the memory module 51 in accordance with each access data included in the changed access profile information 80 based on the changed access profile information 80. The access profile information 80 may be changed multiple times as necessary.

In step S170, the pseudo-access load generation mechanism 30 generates a pseudo-access load according to the set values stored in multiple internal registers, such as the read/write ratio and the data bandwidth when accessing the memory module 51. In this way, the pseudo-access load generation mechanism 30 can autonomously generate a pseudo-access load according to the setting values stored in a plurality of internal registers. In this embodiment, the mode in which an access load is generated based on the setting values stored in a plurality of internal registers is defined as a self-running mode.

In step S170, when the time during which the pseudo access load is generated in the self-running mode reaches a certain time or when, for example, the processor 20 instructs the termination, the pseudo access load generation unit 33 ends the generation of the pseudo access load in the self-running mode. Thereafter, the pseudo-access load generation mechanism 30 proceeds to the process of step S180.

In step S180, the pseudo access load generation mechanism 30 determines whether or not an instruction to change the pseudo access load has been received from the processor 20, for example. As described above, the pseudo-access load generation mechanism 30 can adjust the load level of the generated pseudo-access load by, for example, switching the self-running mode information to be adopted from among multiple stored pieces of self-running mode information in response to instructions from the processor 20. Alternatively, the pseudo-access load generation mechanism 30 can adjust the load level of the pseudo-access load by the process of the processor 20 for writing the optimum self-running mode information in the self-running mode information storage unit 36 each time before generating the pseudo-access load in the self-running mode. If it is determined that an instruction to change the pseudo access load has been received, the pseudo access load generation mechanism 30 proceeds to the process of step S190. On the other hand, if it is determined that the instruction to change the pseudo access load has not been received, the pseudo access load generation mechanism 30 ends the process shown in the flowchart of FIG. 3.

In step S190, the pseudo-access load generation mechanism 30 changes the setting values stored in the internal register by switching the information for the self-running mode or writing new information for the self-running mode. Then, the pseudo-access load generation unit 33 accesses the memory module 51 according to the changed setting value, thereby generating a pseudo-access load. The self-running mode information (i.e., the setting value) may be changed multiple times as necessary.

As described above, the pseudo access load generation mechanism 30 according to the first embodiment is provided inside the computer 10. The pseudo-access load generation mechanism 30 includes a pseudo-access load generation unit 33 that generates a pseudo-access load on the memory module 51 based on the access profile information 80 acquired by the profile acquisition unit 35 or the information for the self-running mode stored by the information storage unit 36 for the self-running mode. Therefore, according to the pseudo-access load generation mechanism 30 disclosed in the present embodiment, it is possible to generate a sufficiently high load state of the memory module 51 that corresponds to the load state of the memory module 51 in a case where the plurality of application programs 23 to 26 are executed by the processor 20, which is different from a case where the memory module 51 is accessed via an external IF 70, for example.

Furthermore, the pseudo-access load generation mechanism 30 according to the present embodiment is provided inside the computer 10, separately from the processor 20 of the computer 10. Therefore, it is possible to restrict the influence to the operation of the processor 20 since the pseudo-access load generation mechanism 30 applies the pseudo-access load on the memory module 51. Therefore, in a computer 10 having a pseudo access load generation mechanism 30, it is possible to properly verify the operation of an application program executed by a processor 20.

### Second Embodiment

Next, a pseudo-access load generation mechanism according to a second embodiment of the present disclosure and a computer including the pseudo-access load generation mechanism will be described.

The pseudo access load generation mechanism 30 according to the first embodiment described above includes the CPU core 31 and the firmware 32, and the profile acquisition unit 35 and the access mode management unit 37 are embodied by the software program 34. Alternatively, the pseudo access load generation mechanism can also realize all of its functions by hardware circuits, rather than by the software program 34.

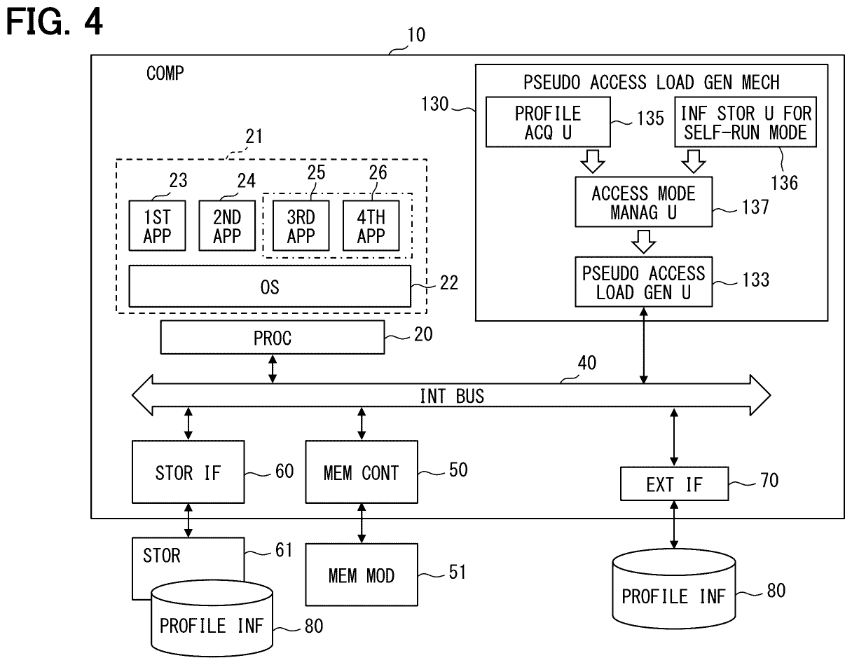

FIG. 4 is a configuration diagram showing the overall configuration of the pseudo-access load generation mechanism 130 when the functions of the pseudo-access load generation mechanism 130 are realized by a hardware circuit, a computer 10 equipped with the pseudo-access load generation mechanism 130, and the overall configuration of peripheral devices of the computer 10. The configuration other than the pseudo access load generation mechanism 130 is similar to that of the first embodiment, and therefore a description thereof will be omitted.

In this embodiment, the pseudo-access load generation unit 133, similar to the pseudo-access load generation unit 33 in the first embodiment, is a hardware circuit for inputting and outputting data, which is connected to the internal bus 40 and configured to be able to access the memory module 51 via the internal bus 40. The access mode management unit 137 can be configured, for example, as a switching circuit that selects either the access profile information 80 from the profile acquisition unit 135 or the information for self-running mode from the information storage unit 136 for self-running mode in response to a mode selection instruction signal from the processor 20 and provides the selected information to the pseudo-access load generation unit 133.

The profile acquisition unit 135 can be configured to include, for example, an input interface circuit that reads out each access data of the access profile information 80 loaded into the memory module 51, and a buffer circuit that temporarily stores the read access data. The self-running mode information storage unit 136 has a plurality of internal registers for storing information for the self-running mode, similar to the self-running mode information storage unit 36 of the first embodiment.

Thus, the pseudo access load generation mechanism 130 can also realize all of its functions by hardware circuits, rather than by the software program 34.

Although the preferred embodiments of the present disclosure have been explained above, the present disclosure is not limited to the above-described embodiments, and can be implemented by various modifications without departing from the spirit of the present disclosure.

For example, in the first and second embodiments described above, the pseudo-access load generation mechanisms 30, 130 are configured to be able to select and execute either a profile reproduction mode in which a pseudo-access load is applied to the memory module 51 based on the access profile information 80, or a self-running mode in which a pseudo-access load is applied to the memory module 51 based on information for the self-running mode. Alternatively, the pseudo-access load generation mechanisms 30 and 130 may be configured to be able to execute only one of the profile reproduction mode and the self-running mode. In this case, in the pseudo access load generation mechanisms 30 and 130, the access mode management unit 137, the profile acquisition unit 135 for the other mode, or the information storage unit 136 for the self-running mode can be omitted.

The present disclosure discloses multiple technical ideas listed below and multiple combinations thereof. The combination of a plurality of technical ideas described below applies not only to the pseudo-access load generation mechanisms 30 and 130 but also to the computer 10 equipped with the pseudo-access load generation mechanisms 30 and 130.

### Technical Feature 1

A pseudo-access load generation mechanism is capable of simulating an access load on a memory module in a case where a processor is designed to execute a plurality of application programs in a computer while executing a certain number of application programs less than the number of the plurality of application programs using the processor for operation verification. The pseudo access load generation mechanism includes: at least one of (i) a circuit and (ii) a processor having a memory storing computer program code. The at least one of the circuit and the processor having the memory is configured to cause the pseudo-access load generation mechanism to provide: an acquisition or storage unit that acquires or stores information for applying a pseudo access load to the memory module; and a pseudo-access load generation unit that generates the pseudo access load on the memory module based on the information acquired or stored by the acquisition or storage unit. The pseudo-access load generation mechanism is provided inside the computer separately from the processor.

### Technical Feature 2

In the pseudo-access load generation mechanism according to technical feature 1, the processor and the memory module are connected via an internal bus, and the pseudo-access load generation unit is connected to the internal bus and is configured to be able to access the memory module via the internal bus.

### Technical Feature 3

In the pseudo-access load generation mechanism according to technical feature 1 or 2, the information for applying the pseudo access load to the memory module acquired by the acquisition or storage unit is access profile information that defines a plurality of access data in sequence, including at least an address of the memory module to be accessed, a type of access, and a data size.

### Technical Feature 4

In the pseudo-access load generation mechanism according to technical feature 3, the access profile information is loaded into the memory module via a storage interface provided in the computer or an external interface, and the acquisition or storage unit acquires the access profile information by reading the access profile information from the memory module.

### Technical Feature 5

In the pseudo-access load generation mechanism according to any one of technical features 1 to 4, the information for applying the pseudo access load to the memory module stored by the acquisition or storage unit is self-running mode information including at least a read/write ratio and a data size per unit time when accessing the memory module, and the pseudo access load generation unit generates the pseudo access load according to the read/write ratio and the data size per unit time indicated by the self-running mode information.

### Technical Feature 6

In the pseudo-access load generation mechanism according to technical feature 5, the acquisition or storage unit has an internal register for storing the self-running mode information.

### Technical Feature 7

In the pseudo-access load generation mechanism according to technical feature 1 or 2, the acquisition or storage unit stores self-running mode information including at least a read/write ratio and a data size per unit time when accessing the memory module, and the acquisition or storage unit acquires access profile information that defines a plurality of access data in sequence, including at least an address of the memory module to be accessed, a type of access, and a data size. The pseudo-access load generation mechanism further includes a mode management unit that manages which mode to execute in the pseudo-access load generation unit between a self-running mode for applying the pseudo access load to the memory module based on the self-running mode information and a profile reproduction mode for applying the pseudo access load to the memory module based on the access profile information.

### Technical Feature 8

In the pseudo-access load generation mechanism according to any one of technical features 1 to 7, the processor instructs the pseudo-access load generation mechanism to generate the pseudo access load on the memory module when the processor executes the certain number of application programs less than the number of the plurality of application programs for operation verification.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause the pseudo-access load generation mechanism to perform functions” should be understood that (i) only the circuit can cause the pseudo-access load generation mechanism to perform all the functions, (ii) only the processor can cause the pseudo-access load generation mechanism perform all the functions, or (iii) the circuit can cause the pseudo-access load generation mechanism to perform at least one of the functions and the processor can cause the pseudo-access load generation mechanism to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A pseudo-access load generation mechanism for simulating an access load on a memory module in a case where a processor is designed to execute a plurality of application programs in a computer while executing a certain number of application programs less than the number of the plurality of application programs using the processor for operation verification, the pseudo access load generation mechanism comprising:
an acquisition or storage unit that acquires or stores information for applying a pseudo access load to the memory module; and
a pseudo-access load generation unit that generates the pseudo access load on the memory module based on the information acquired or stored by the acquisition or storage unit, wherein:
the pseudo-access load generation mechanism is provided inside the computer separately from the processor.

2. The pseudo-access load generation mechanism according to claim 1, wherein:
the processor and the memory module are connected via an internal bus; and
the pseudo-access load generation unit is connected to the internal bus and configured to access the memory module via the internal bus.

3. The pseudo-access load generation mechanism according to claim 1, wherein:
the information for applying the pseudo access load to the memory module acquired by the acquisition or storage unit is access profile information that defines a plurality of access data in sequence, including at least an address of the memory module to be accessed, a type of access, and a data size.

4. The pseudo-access load generation mechanism according to claim 3, wherein:
the access profile information is loaded into the memory module via a storage interface provided in the computer or an external interface; and
the acquisition or storage unit acquires the access profile information by reading the access profile information from the memory module.

5. The pseudo-access load generation mechanism according to claim 1, wherein:
the information for applying the pseudo access load to the memory module stored by the acquisition or storage unit is self-running mode information including at least a read/write ratio and a data size per unit time when accessing the memory module; and
the pseudo access load generation unit generates the pseudo access load according to the read/write ratio and the data size per unit time indicated by the self-running mode information.

6. The pseudo-access load generation mechanism according to claim 5, wherein:
the acquisition or storage unit has an internal register for storing the self-running mode information.

7. The pseudo-access load generation mechanism according to claim 1, wherein:
the acquisition or storage unit stores self-running mode information including at least a read/write ratio and a data size per unit time when accessing the memory module; and
the acquisition or storage unit acquires access profile information that defines a plurality of access data in sequence, including at least an address of the memory module to be accessed, a type of access, and a data size,
the pseudo-access load generation mechanism further comprising:
a mode management unit that manages which mode to execute in the pseudo-access load generation unit between a self-running mode for applying the pseudo access load to the memory module based on the self-running mode information and a profile reproduction mode for applying the pseudo access load to the memory module based on the access profile information.

8. The pseudo-access load generation mechanism according to claim 1, wherein:
the processor instructs the pseudo-access load generation mechanism to generate the pseudo access load on the memory module when the processor executes the certain number of application programs less than the number of the plurality of application programs for operation verification.

9. The pseudo-access load generation mechanism according to claim 1, further comprising:
at least one of (i) a circuit and (ii) a processor having a memory storing computer program code,
wherein the at least one of the circuit and the processor having the memory is configured to cause the pseudo-access load generation mechanism to provide at least one of: the acquisition or storage unit; and the pseudo-access load generation unit.

10. A computer designed to execute a plurality of application programs by a processor, the computer comprising:
a memory module that is accessed by the processor for writing and reading data when the plurality of application programs are executed; and
a pseudo-access load generation mechanism including an acquisition or storage unit that acquires or stores information for applying a pseudo access load to the memory module, and a pseudo-access load generation unit that generates the pseudo access load on the memory module based on the information acquired or stored by the acquisition or storage unit, wherein:
the pseudo-access load generation mechanism is provided inside the computer separately from the processor; and
the pseudo-access load generation mechanism simulates an access load on the memory module in a case where the processor executes the plurality of application programs while executing a certain number of application programs less than the number of the plurality of application programs using the processor for operation verification.
